(19) United States
(12) Patent Application Publication
(10) Pub. No.: US 2013/0056371 A1
(43) Pub. Date: Mar. 7, 2013

(54) Methods and Apparatus for Roller and Tray Cover

(71) Applicants: Ben D. Leonard, Toronto (CA); Vance A. Macdonald, Calgary (CA)

(72) Inventors: Ben D. Leonard, Toronto (CA); Vance A. Macdonald, Calgary (CA)

(73) Assignee: Kovrd Products, Inc.

(21) Appl. No.: 13/602,699

(22) Filed: Sep. 4, 2012

Related U.S. Application Data
(60) Provisional application No. 61/530,862, filed on Sep. 2, 2011.

(51) Int. Cl. B65D 81/24; B23P 25/00

(52) U.S. Cl. 206/207; 29/527.1

(57) ABSTRACT

Methods and apparatus for a paint roller and tray cover according to various aspects of the present invention comprise a body that is configured to be positioned proximate to a paint tray to separate the reduce the rate at which paint contained within the paint tray dehydrates. The cover may be configured with one or more receiving portions adapted to receive an object such as a paint can.

### CROSS-REFERENCES TO RELATED APPLICATIONS

This application claims the benefit of U.S. Provisional Patent Application No. 61/530,862, filed Sep. 2, 2011, and incorporates the disclosure of the application by reference.

### BACKGROUND OF INVENTION

Paint and paint application devices are subject to oxidation, dehydration, and contaminants when being used or stored. To avoid dehydration after use, paint is stored in an air tight container and paint application devices are cleaned when not in use. During a painting process, there are often instances when the painting process is temporarily interrupted or halted for minutes or hours at a time. During these times it is necessary to protect the unused paint from drying out. A common method is to return the unused paint to its air tight container and clean the application device. This method may be time consuming and wasteful.

### SUMMARY OF THE INVENTION

Methods and apparatus for a paint roller and tray cover according to various aspects of the present invention comprise a body that is configured to be positioned proximate to a paint tray to separate the reduce the rate at which paint contained within the paint tray dehydrates. The cover may be configured with one or more receiving portions adapted to receive an object such as a paint can.

### BRIEF DESCRIPTION OF THE DRAWINGS

A more complete understanding of the present invention may be derived by referring to the detailed description when considered in connection with the following illustrative figures. In the following figures, like reference numbers refer to similar elements and steps throughout the figures.

FIG. 1A representatively illustrates a cover in accordance with an exemplary embodiment of the present invention;

FIG. 1B representatively illustrates the placement of the cover over paint tray and paint roller;

FIG. 1C representatively illustrates the placement of the cover over paint tray and paint roller with a sealing element attached;

FIG. 2 representatively illustrates a top view of the cover;

FIG. 3 representatively illustrates a side view of the cover;

FIG. 4 representatively illustrates placement of paint cans into a receiving element in accordance with an exemplary embodiment of the present invention; and

FIG. 5 representatively illustrates an alternative configuration of the receiving element.

### DETAILED DESCRIPTION OF EXEMPLARY EMBODIMENTS

The present invention may be described in terms of functional block components and various processing steps. Such functional blocks may be realized by any number of components configured to perform the specified functions and achieve the various results. For example, the present invention may employ various types of covers, seals, storage equipment for various types of painting materials and the like, which may carry out a variety of functions. In addition, the present invention may be practiced in conjunction with any number of processes such as temporary covering and protection of a paint tray, the protection and storage of paint supplies, and providing a spill proof storage container, and the system described is merely one exemplary application for the invention. Further, the present invention may employ any number of conventional techniques for preventing materials from drying out, spilling, providing protection against damage, and/or secure storage.

Methods and apparatus for covering a paint tray according to various aspects of the present invention may operate in conjunction with any suitable paint application system and/or paint material. Various representative implementations of the present invention may be applied to any system for covering and storing paint supplies.

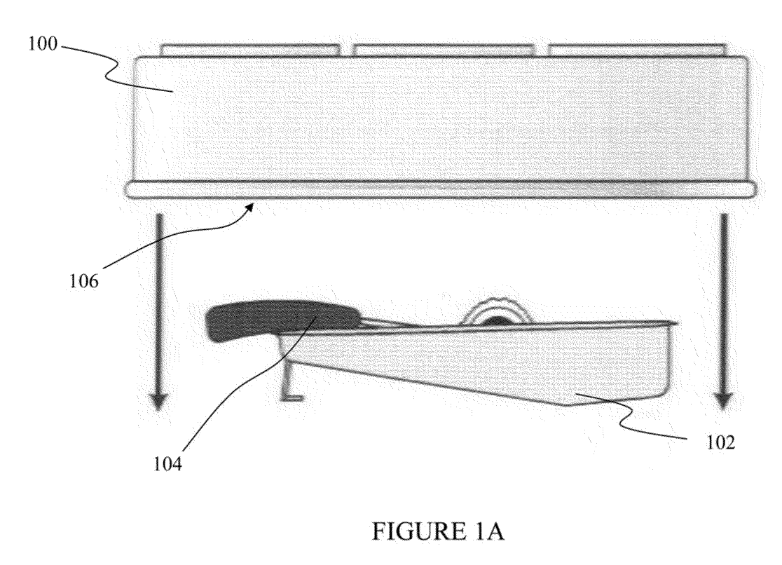

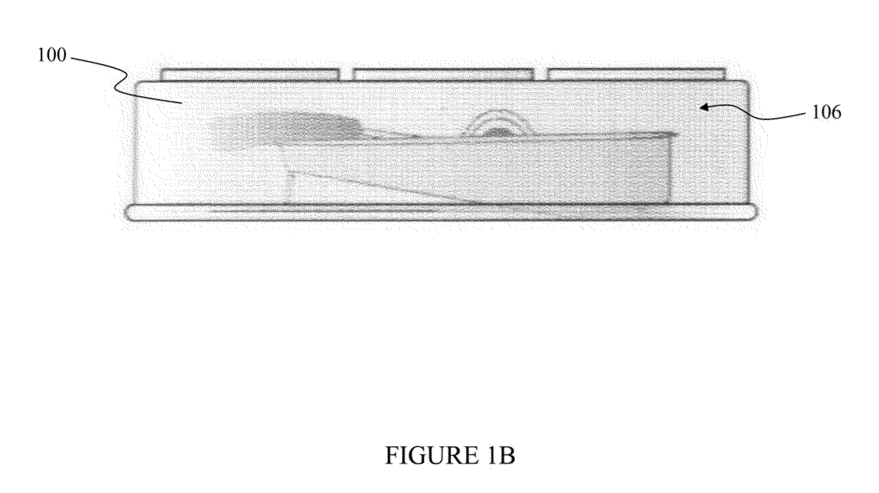

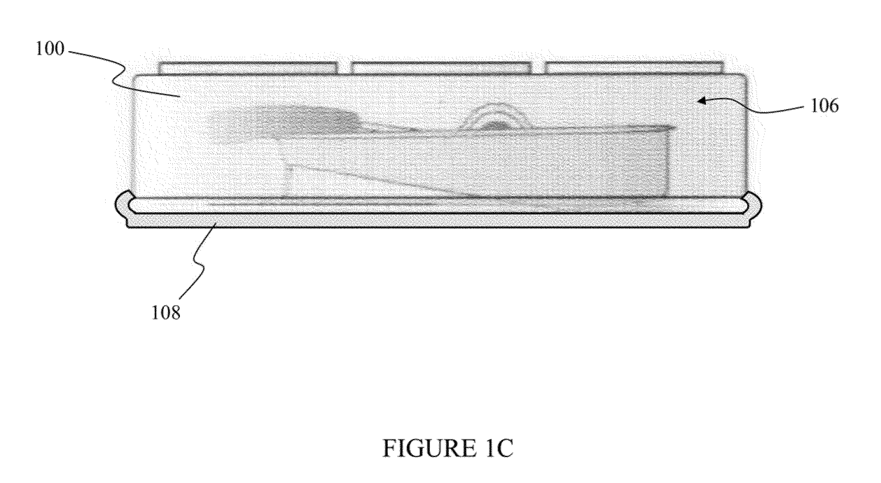

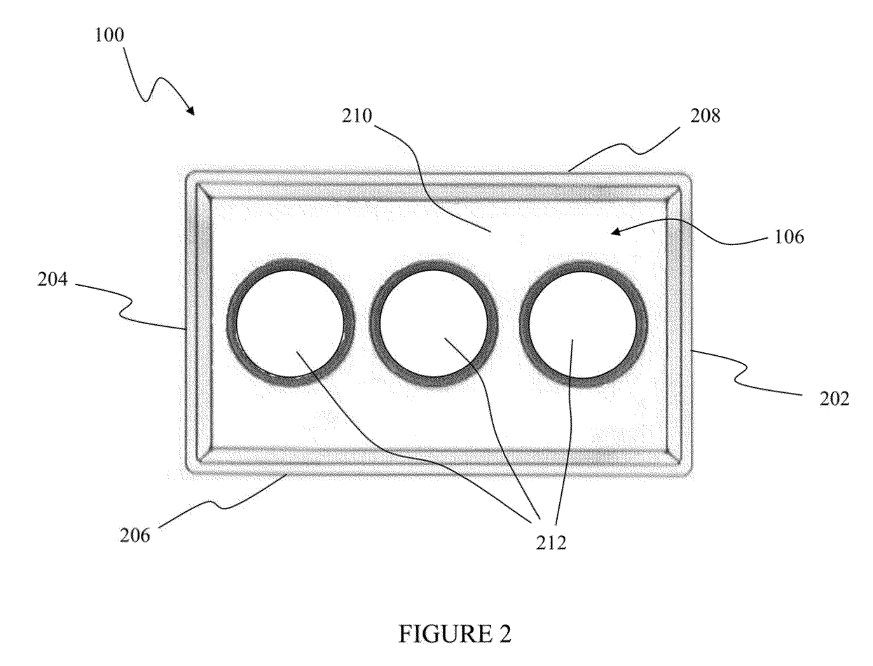

Referring now to FIGS. 1A and 1B, in an exemplary embodiment of the present invention a cover 100 may he configured to cover a paint tray 102 having one or more paint application devices 104 disposed at least partially within a paint well of the paint tray 102. The cover 100 may comprise any suitable device for covering an object within an interior volume 106 to help protect a volume of paint contained within the paint well of the paint tray 102 and/or a paint application device 104 from oxidation, dehydration, contaminants such as dust, and/or inadvertent waste of the paint caused by object falling into the paint tray 102. For example, referring now to FIG. 2, in a representative embodiment, the cover 100 may comprise a rigid or semi-rigid body having a pair of generally opposing wall elements 202, 204, 206, 208, wherein each wall element is connected on a first and second end to another wall element. Each wall element 202, 204, 206, 208 may further be connected on a third end portion to a surface 210 to form the interior volume 106.

The wall elements 202, 204, 206, 208 may generally be disposed in a vertical manner relative to the surface 210 when the cover 100 is positioned over the paint tray 100. For example in one embodiment, the wall elements 202, 204, 206, 208 may form a right angle with the first surface 210. In another representative embodiment, the wall elements 202, 204, 206, 208 may be angled outward such that the area formed by the surface 210 is less than an area formed by a fourth end portion of the wall elements 202, 204, 206, 208. The wall elements 202, 204, 206, 208 and the surface 210 may be coupled together by any suitable method such as with mechanical fasteners, adhesive, welding, or the like. Alternatively, the wall elements 202, 204, 206, 208 and the surface 210 may be formed as a single one-piece structure such as a molded thermoplastic.

The wall elements 202, 204, 206, 208 and the first surface 210 may also be formed of any suitable material such as wood, metal, or plastic. The material used to form wall elements 202, 204, 206, 208 and the first surface 210 may be suitably adapted to provide sufficient strength such that the cover 100 can withstand the application of weight or similar force to the first surface 210. For example, when the cover 100 is positioned over the paint tray 102, the wall elements 202, 204, 206, 208 and the surface 210 may withstand the application of a load up of up to 100 pounds on the surface 210 without any permanent and/or temporary buckling or other similar displacement of the wall elements 202, 204, 206, 208 and the surface 210. Alternatively, the material forming the wall elements 202, 204, 206, 208 and the first surface 210 may be configured to be light weight and may experience some plastic deformation under an applied load.

Referring again to FIGS. 1A and 1B, in one embodiment, the cover 100 may be configured to be fit or positioned over a paint tray 102 such that the wall elements 202, 204, 206, 208 form a seal against whatever surface the paint tray 102 is resting upon. Referring now to FIG. 1C, in an alternative embodiment, the cover 100 may further comprise a sealing element 108 that is suitably adapted to couple to the wall elements 202, 204, 206, 208. For example, the sealing element 108 may be configured to be positioned under paint tray 102 and be suitably adapted to provide a surface for capturing any paint spilled or otherwise not contained by the paint tray 102. The sealing element 108 may comprise a shallow reservoir for holding spilled paint. The sealing element 108 may couple to the wall elements 202, 204, 206, 208 by any suitable manner such as with locking tabs, compression fit, snapping elements, mating edge pieces, and the like. The coupling between the sealing element 108 and the wall elements 202, 204, 206, 208 may form a seal between the interior volume 106 and a surrounding ambient environment when engaged to help prevent any paint in the paint tray 102 from drying out. The coupling between the sealing element 108 and the wall elements 202, 204, 206, 208 may also allow the cover 100 to be lifted and moved from one location to another while the paint tray 102 is positioned within the interior volume 106 of the cover 100.

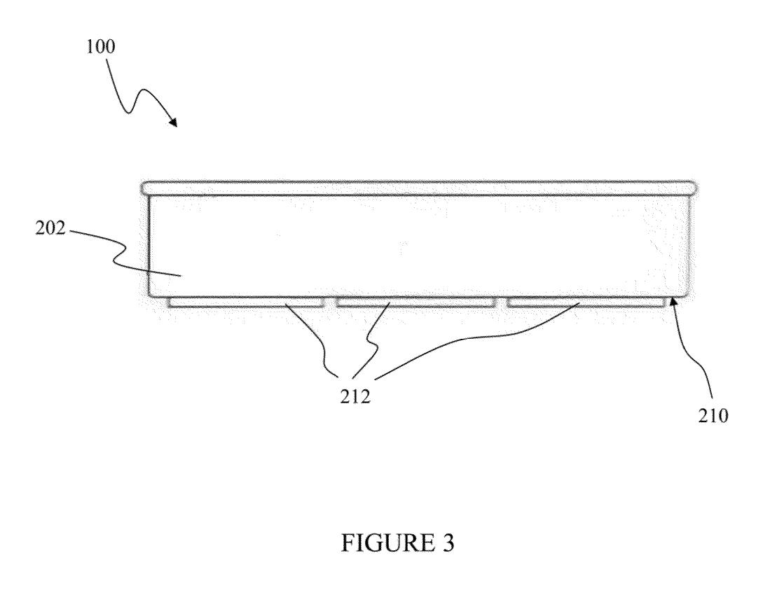

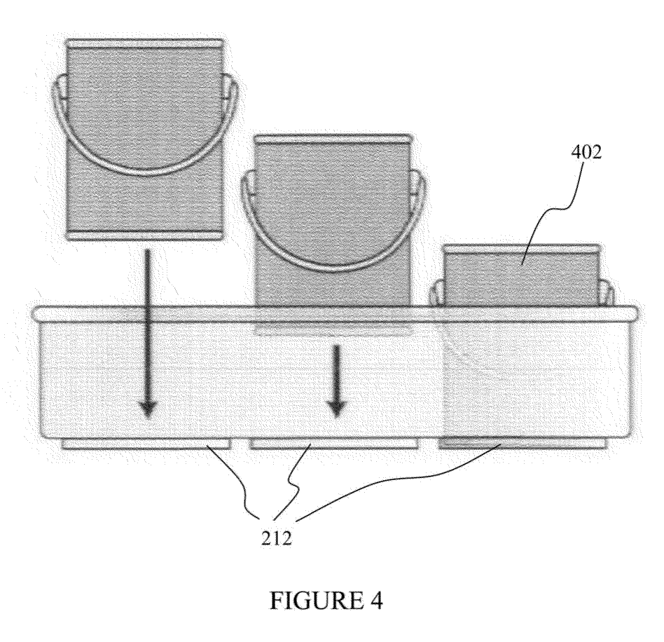

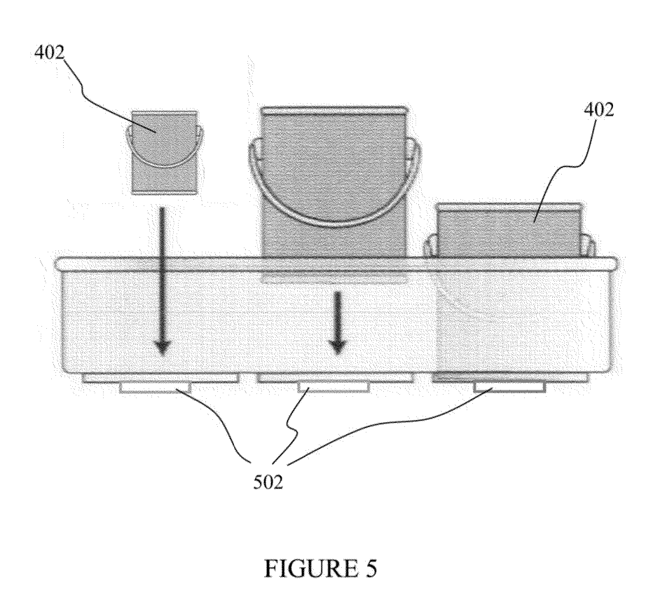

Referring now to FIGS. 2, 3, and 4, the surface 210 may be configured with at least one receiving element 212 for securing items within the interior volume 106 when the cover 100 is inverted. The receiving element 212 may comprise any suitable device or structure. For example, in one representative embodiment, the receiving element 212 may comprise one or more molded features set into the surface 210 such as a recess configured to conform to the shape of a paint can 402, wherein a portion of the paint can 402 may fit into the recess to prevent undesired movement and/or tipping of the paint can 402 if the cover 100 is moved. The recess may be formed as any suitable shape or size to account for varying sizes of paint cans 402. Referring now to FIG. 5, in another embodiment, a second smaller recess 502 may be formed within the receiving element 212 such that the receiving element 212 may receive multiple different sized paint cans 402.

In another embodiment, the receiving element 212 may comprise a raised element on the first surface 210 suitably adapted to surround a portion of an item such as a paint can 402 that is placed on the first surface to prevent undesired movement of the item. Alternatively, the raised element may comprise a series of raised sections adapted to engage an item placed on the first surface 210 at multiple locations to prevent undesired movement of the item.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

In the foregoing specification, the invention has been described with reference to specific exemplary embodiments. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

As used herein, the terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

1. A cover for a paint tray and paint application device, comprising:
a first pair of opposing substantially rectangular semi-rigid wall elements;
a second pair of opposing substantially rectangular semi-rigid wall elements, wherein each of the first and second pair of opposing wall elements comprises a first end portion and a second end portion opposite the first end portion adapted to couple the first end portion of the first pair of opposing substantially rectangular rigid wall elements to the first end portion of the second pair of opposing substantially rectangular rigid wall elements and the second end portion of the first pair of opposing substantially rectangular rigid wall elements to the second end portion of the second pair of opposing substantially rectangular rigid wall elements;
a semi-rigid surface, wherein each of the first and second pair of opposing wall elements comprises a third end portion adapted to couple the semi-rigid surface to the first and second pair of opposing wall elements to form an open volume adapted to be positioned over and substantially enclose the paint tray and the paint application device; and
a receiving element disposed on the semi-rigid surface, wherein the receiving element is configured to receive an item within the open volume.

2. A cover according to claim 1, wherein the receiving element comprises a circular recess formed into the semi-rigid surface.

3. A cover according to claim 2, further comprising a second receiving element disposed within the recess, wherein the second receiving element is configured to receive a second item comprising a smaller area than that formed by the recess.

4. A cover according to claim 1, further comprising a second receiving element disposed on the semi-rigid surface and adjacent to the first receiving element.

5. A cover according to claim 1, further comprising a sealing element configured to selectively couple to the first and second pair of opposing wall elements to seal the open volume from a surrounding environment.

6. A method of forming a cover for a paint tray, comprising:
forming an open volume sufficient to substantially enclose the paint tray by coupling a first surface to a first and second set of opposing wall elements, wherein:
each of the first and second pair of opposing wall elements comprises a first end portion and a second end portion opposite the first end portion;
the first end portion of the first pair of opposing substantially rectangular wall elements is coupled to the first end portion of the second pair of opposing substantially rectangular wall elements; and
the second end portion of the first pair of opposing substantially rectangular wall elements is coupled to the second end portion of the second pair of opposing substantially rectangular wall elements; and
positioning a receiving element on the first surface, wherein the receiving element is configured to receive an item within the open volume.

7. A method of forming a cover according to claim 6, wherein positioning the receiving element on the first surface comprises forming a circular recess into the first surface.

8. A method of forming a cover according to claim 7, further comprising forming a second receiving element within the recess, wherein the second receiving element is configured to receive an item comprising a smaller area than that formed by the recess.

9. A method of forming a cover according to claim 6, further comprising positioning a second receiving element on the first surface adjacent to the first receiving element.

10. A method of forming a cover according to claim 6, further comprising sealing the open volume from a surrounding environment by selectively coupling a sealing element to the first and second set of opposing wall elements.
